(19) United States
(12) Patent Application Publication
(10) Pub. No.: US 2026/0197610 A1
(43) Pub. Date: Jul. 9, 2026

(54) PROXY SERVER AND POSITIONING METHOD

(71) Applicant: ASUSTeK COMPUTER INC., Taipei City (TW)

(72) Inventors: Cho-Jan Chen, Taipei City (TW); Chang-Yi Shen, Taipei City (TW); Chun-Hsien Huang, Taipei City (TW)

(73) Assignee: ASUSTeK COMPUTER INC., Taipei City (TW)

(21) Appl. No.: 19/062,062

(22) Filed: Feb. 25, 2025

(30) Foreign Application Priority Data
Jan. 9, 2025 (TW) 114100924

(51) Int. Cl. H04W 4/38; H04W 4/02; H04W 84/18; H04W 88/08

(52) U.S. Cl. CPC H04W 4/38; H04W 4/026; H04W 84/18; H04W 88/08

(57) ABSTRACT

Provided are a proxy server and a positioning method. The proxy server applies to a mesh network. The proxy server connects to the mesh network and a cloud service platform. The mesh network includes multiple wireless access points. The wireless access points include a first wireless access point and a second wireless access point. The proxy server receives a longitude, a latitude, an air pressure value, and a temperature value from the second wireless access point and transmits the longitude and the latitude to the cloud service platform. The proxy server receives a ground air pressure value and a ground temperature value from the cloud service platform. The proxy server calculates an altitude of the second wireless access point according to the air pressure value, the temperature value, the ground air pressure value, and the ground temperature value, and transmits the altitude to the second wireless access point.

### CROSS-REFERENCE TO RELATED APPLICATION

This application claims the priority benefit of Taiwan application serial no. 114100924 filed on Jan. 9, 2025. The entirety of the above-mentioned patent application is hereby incorporated by reference herein and made a part of this specification.

### BACKGROUND

### Technical Field

This disclosure relates to a positioning technology, and particularly relates to a proxy server and a positioning method.

### Related Art

Generally, the positioning method for a wireless access point may exemplify obtaining location information through a built-in Global Navigation Satellite System (GNSS) chip, a paid cloud service platform, or a nearby electronic device. Alternatively, the installation personnel may manually input the location information into the wireless access point.

However, the aforementioned positioning methods require expensive costs and/or additional human resources. Therefore, how to effectively reduce the positioning cost of wireless access points is one of the problems that those skilled in the art are eager to solve.

### SUMMARY

The disclosure provides a proxy server and a positioning method, capable of significantly reducing positioning cost of wireless access points.

The disclosure provides a proxy server applicable to a mesh network. The proxy server connects the mesh network and a cloud service platform. The mesh network includes multiple wireless access points. The wireless access points include a first wireless access point and a second wireless access point. The proxy server receives a longitude, a latitude, an air pressure value, and a temperature value from the second wireless access point, and sends the longitude and latitude to the cloud service platform. The proxy server receives a ground air pressure value and a ground temperature value from the cloud service platform. The proxy server calculates an altitude of the second wireless access point according to the air pressure value, the temperature value, the ground air pressure value, and the ground temperature value, and sends the altitude to the second wireless access point.

The disclosure also provides a positioning method applicable to a proxy server, a mesh network, and a cloud service platform. The mesh network includes multiple wireless access points. The wireless access points include a first wireless access point and a second wireless access point. The positioning method includes the following. A longitude, a latitude, an air pressure value, and a temperature value are received from the second wireless access point through the proxy server, and the longitude and the latitude are sent to the cloud service platform. A ground air pressure value and a ground temperature value are received from the cloud service platform through the proxy server. An altitude of the second wireless access point is calculated according to the air pressure value, the temperature value, the ground air pressure value, and the ground temperature value through the proxy server, and the altitude is sent to the second wireless access point.

Based on the above, the proxy server and the positioning method provided by the disclosure may calculate the altitude of the second wireless access point through the proxy server to reduce the positioning cost.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a proxy server, a mesh network, and a cloud service platform according to an embodiment of the disclosure.

FIG. 2 is a flowchart of a positioning method according to an embodiment of the disclosure.

FIG. 3 is a flowchart of determining a distance calculation method according to an embodiment of the disclosure.

FIG. 4 is a flowchart of a positioning method according to an embodiment of the disclosure.

### DESCRIPTION OF THE EMBODIMENTS

Some embodiments of the disclosure are described in detail below with reference to the drawings. When the same reference numerals appear in different drawings, they will be considered as the same or similar components. These embodiments are only a part of the disclosure and do not disclose all possible implementations of the disclosure. More precisely, these embodiments are only examples within the scope of the patent claims of the disclosure.

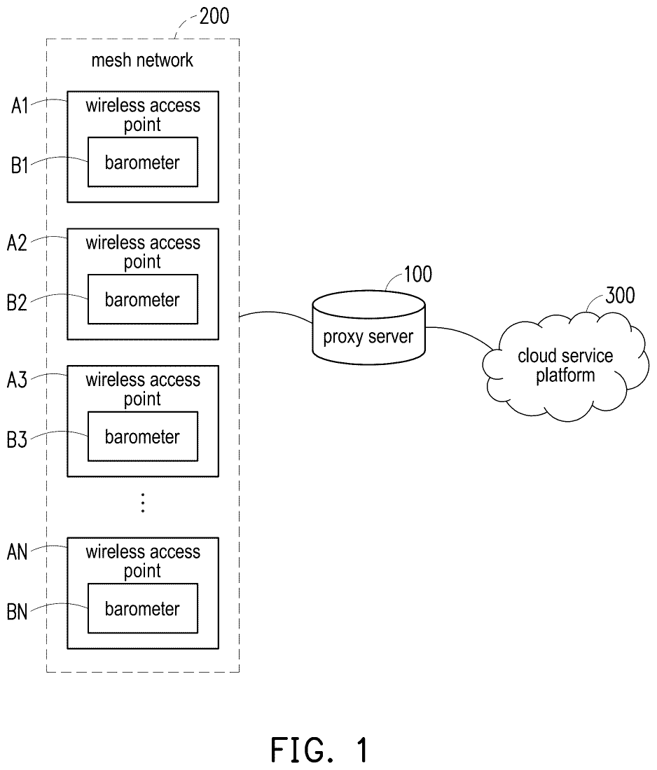

FIG. 1 is a schematic diagram of a proxy server, a mesh network, and a cloud service platform according to an embodiment of the disclosure. Please refer to FIG. 1. A proxy server 100 is applicable to a mesh network 200. The mesh network 200 includes multiple wireless access points A1 to AN. In other words, the mesh network 200 is composed of multiple wireless access points A1 to AN. In this embodiment, the wireless access point A1 (also referred to as the first wireless access point) is the master wireless access point in the mesh network 200, and the wireless access points A2 to AN are the agent wireless access points in the mesh network 200. The proxy server 100 connects the mesh network 200 and a cloud service platform 300. Specifically, the proxy server 100 serves as a relay station between the mesh network 200 and the cloud service platform 300.

The wireless access points A1 to AN (or the proxy server 100, the cloud service platform 300) may have a processing unit (for example, a processor but not limited thereto), a communication unit (for example, various communication chips, mobile communication chips, Bluetooth chips, WiFi chips, etc., but not limited thereto), a storage unit (for example, removable random access memory, flash memory, hard disk, etc., but not limited thereto), and other necessary components for operating the wireless access points A1 to AN (or the proxy server 100, the cloud service platform 300). In this embodiment, the wireless access points A1 to AN may include barometers B1 to BN respectively. The wireless access points A1 to AN may exemplify N in number, where the value of N may be set according to actual needs, and the disclosure is not limited thereto.

The cloud service platform 300 may provide one or more cloud services. The cloud service platform 300 may include, but is not limited to, Google Geolocation Service for providing location information and/or National Weather Service for providing weather information.

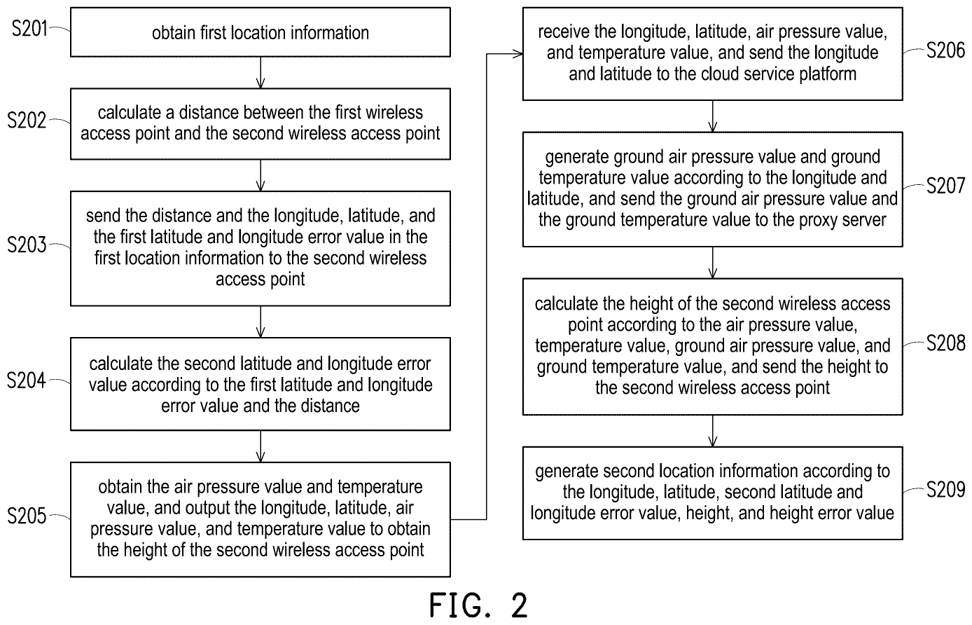

FIG. 2 is a flowchart of a positioning method according to an embodiment of the disclosure. Please refer to FIG. 1 and FIG. 2. When it is desired to obtain location information of any one or more of the agent wireless access points A2 to AN (for example, the wireless access point A2), the proxy server 100, the wireless access points A1, A2 and the cloud service platform 300 may exemplify executing the positioning method as shown in FIG. 2 to reduce the positioning cost.

In step S201, the first wireless access point A1 (i.e., the master wireless access point) may obtain first location information. Specifically, the first wireless access point A1 may first obtain its own first location information. For example, the wireless access point A1 may have a built-in satellite positioning chip (not drawn), and the wireless access point A1 may obtain the first location information through this satellite positioning chip. For example, the wireless access point A1 may receive location information from nearby electronic devices (for example, smartphones) to serve as the first location information. For example, the wireless access point A1 may connect to the cloud service platform 300 (for example, Google Geolocation Service) that provides location information to obtain the first location information. For example, if the wireless access point A1 stores a setup address, the wireless access point A1 may use the setup address as the first location information. Specifically, when the wireless access point A1 is installed, the installer may exemplify inputting the setup address into the wireless access point A1 to facilitate management of the wireless access point A1.

In this embodiment, the first location information may include but is not limited to longitude, latitude, latitude and longitude error value (also called, first latitude and longitude error value), altitude (also called, first altitude), and altitude error value (also called, first altitude error value). In this embodiment, the longitude in the first location information of the wireless access point A1 may exemplify −73.9954996, the latitude may exemplify 40.7535411, the latitude and longitude error value may exemplify 23.626 meters, the altitude may exemplify 28.916929 meters, and the altitude error value may exemplify 9.99 meters.

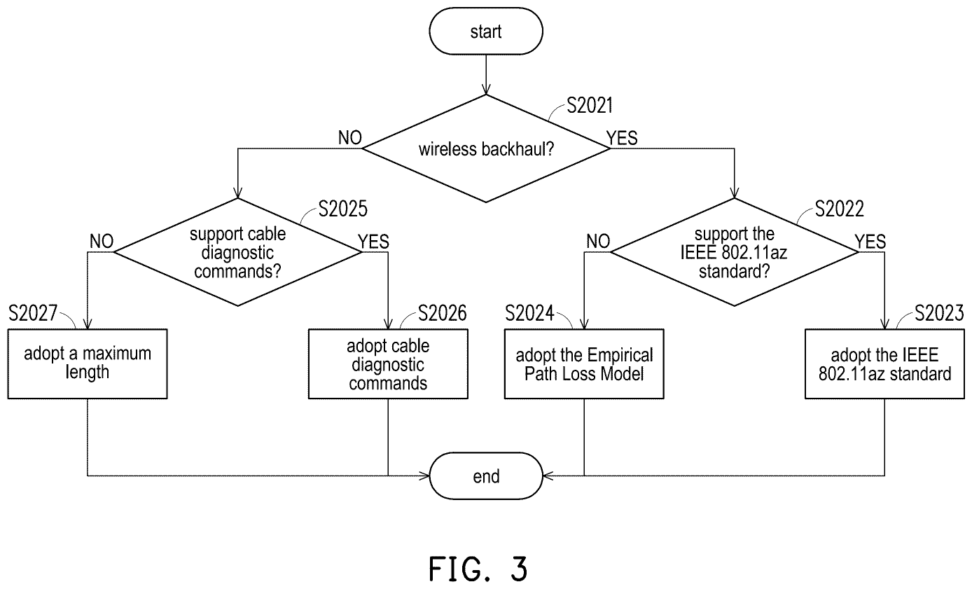

In step S202, the first wireless access point A1 may calculate a distance between the first wireless access point A1 and the second wireless access point A2. In this embodiment, the wireless access point A1 may calculate the distance based on the backhaul type between itself and the wireless access point A2, with specific implementation details may exemplify as shown in FIG. 3. FIG. 3 is a flowchart of determining a distance calculation method according to an embodiment of the disclosure. Please refer to FIG. 3.

In step S2021, the wireless access point A1 may determine whether the backhaul type between itself and the wireless access point A2 is wireless backhaul. Specifically, the wireless access points A1 to AN in the mesh network 200 may exemplify connecting to each other using wireless backhaul or Ethernet backhaul methods. In other words, the backhaul type may exemplify wireless backhaul or Ethernet backhaul. If the backhaul type between the wireless access point A1 and the wireless access point A2 is wireless backhaul, then enter step S2022. Conversely, if the backhaul type between the wireless access point A1 and the wireless access point A2 is Ethernet backhaul, then enter step S2025.

In step S2022, the wireless access point A1 may further determine whether both the wireless access point A1 and the wireless access point A2 support the IEEE 802.11az standard. If both the wireless access point A1 and the wireless access point A2 support the IEEE 802.11az standard, then enter step S2023. Conversely, if the wireless access point A1 and/or the wireless access point A2 do not support the IEEE 802.11az standard, then enter step S2024.

In step S2023, the wireless access point A1 may adopt the IEEE 802.11az standard to calculate this distance. Specifically, the wireless access point A1 may adopt the Fine Timing Measurement (FTM) function in the IEEE 802.11az standard to obtain the distance between itself and the wireless access point A2.

Conversely, in step S2024, the wireless access point A1 may adopt the Empirical Path Loss Model to calculate the distance.

On the other hand, in step S2025, the wireless access point A1 may further determine whether it supports cable diagnostic commands. If the wireless access point A1 supports cable diagnostic commands, then enter step S2026. Conversely, if the wireless access point A1 does not support cable diagnostic commands, then enter step S2027.

In step S2026, the wireless access point A1 may adopt cable diagnostic commands to calculate the distance between itself and the wireless access point A2. Specifically, the wireless access point A1 supporting cable diagnostic commands may estimate a distance based on the length of the Ethernet cable. In other words, the wireless access point A1 may, based on the cable diagnostic commands, calculate the distance between the wireless access point A1 and the wireless access point A2 according to the length of the Ethernet cable used to connect the wireless access point A1 and the wireless access point A2.

Conversely, in step S2027, the wireless access point A1 may adopt a maximum length to serve as the distance between the wireless access point A1 and the wireless access point A2. Specifically, the maximum distance is the maximum length of the Ethernet cable. The wireless access point A1 may adopt the maximum length (exemplify, 100 meters) to serve as the distance between the wireless access point A1 and the wireless access point A2.

After the wireless access point A1 calculates the distance between itself and the wireless access point A2 (exemplify, 30.78 meters), then enter step S203. In step S203, the first wireless access point A1 may send the distance and the longitude, latitude, and the first latitude and longitude error value in the first location information to the second wireless access point A2.

In step S204, the second wireless access point A2 may calculate the second latitude and longitude error value according to the first latitude and longitude error value and the distance. Specifically, the wireless access point A2 may sum up the first latitude and longitude error value (that is, 23.626 meters) and the distance (that is, 30.78 meters) to calculate the second latitude and longitude error value as 54.403 meters.

In step S205, the second wireless access point A2 may obtain the air pressure value and temperature value, and output the longitude, latitude, air pressure value, and temperature value to obtain the altitude of the second wireless access point A2. Specifically, the wireless access point A2 may measure the air pressure value (e.g., 101280 Pa) and temperature value (e.g., 23° C.) of the installation location of the wireless access point A2 through the barometer B2. Thereafter, the wireless access point A2 may output the longitude, latitude, air pressure value, and temperature value to the proxy server 100 to obtain its altitude.

It should be noted that, in order to accommodate practical applications, the distances between the wireless access points A1 to AN in the mesh network 200 are limited to avoid unstable connections and/or connection failures. Therefore, the wireless access points A2 to AN should have the same longitude and latitude as the wireless access point A1. Consequently, the wireless access point A2 may output the longitude and latitude received from the wireless access point A1, along with the air pressure value and temperature value measured through the barometer B2, to the proxy server 100 to obtain the altitude of the wireless access point A2.

In step S206, the proxy server 100 may receive the longitude, latitude, air pressure value, and temperature value from the second wireless access point A2, and send the longitude and latitude to the cloud service platform 300. Specifically, the proxy server 100 may serve as a relay station to send the longitude and latitude received from the wireless access point A2 to the cloud service platform 300.

In step S207, the cloud service platform 300 may generate a ground air pressure value and a ground temperature value according to the longitude and latitude, and send the ground air pressure value and the ground temperature value to the proxy server 100. Specifically, the cloud service platform 300 may exemplify the National Weather Service. The cloud service platform 300 may provide a ground air pressure value and a ground temperature value corresponding to the longitude and the latitude, and return the ground air pressure value and the ground temperature value to the proxy server 100.

In step S208, the proxy server 100 may calculate the altitude of the second wireless access point A2 according to the air pressure value, temperature value, ground air pressure value, and ground temperature value, and send the altitude to the second wireless access point A2. In this embodiment, the proxy server 100 may exemplify inputting the air pressure value, temperature value, ground air pressure value, and ground temperature value into the International Standard Atmosphere (ISA) model to obtain the altitude of the wireless access point A2 (also called the second altitude).

In step S209, the second wireless access point A2 may generate second location information according to the longitude, latitude, second latitude and longitude error value, altitude, and altitude error value. Specifically, the longitude and latitude of the wireless access points A1 to AN in the mesh network 200 should be the same. Therefore, the wireless access point A2 may adopt the longitude and latitude received from the wireless access point A1 as its own longitude and latitude. Additionally, since in step S208 the proxy server 100 only calculates the altitude of the wireless access point A2, without providing the error value of the altitude (also called the second altitude error value), the wireless access point A2 may use the measurement error value of the barometer B2 (that is, 9.99 meters) as the second altitude error value.

As a result, the location information belonging to the wireless access point A2 (that is, the second location information) may include a longitude of −73.9954996, a latitude of 40.7535411, a latitude and longitude error value (that is, the second latitude and longitude error value) of 54.403 meters, an altitude (that is, the second altitude) of 28.097829 meters, and an altitude error value (that is, the second altitude error value) may exemplify 9.99 meters.

It should be noted that the aforementioned embodiment is for positioning the wireless access point A2. The location information for the wireless access points A3 to AN can also be generated by the positioning method of FIG. 2.

It is worth mentioning that using the proxy server 100 as a relay station between the mesh network 200 and the cloud service platform 300 may provide the following advantages.

(1) When adding (or replacing) the cloud service platform 300, the user only needs to adjust the Application Programming Interface (API) between the proxy server 100 and the newly added cloud service platform 300, without the need to adjust the mesh network 200.

(2) When the distance between the wireless access point to be positioned (for example, the wireless access point A3) and the already positioned wireless access point (for example, the wireless access point A2) is close, the proxy server 100 may directly use the altitude of the wireless access point A2 as the altitude of the wireless access point A3, to reduce the positioning cost.

According to the above, the embodiment provided in this disclosure may calculate the location information of the wireless access point A2 (that is, the second location information) by using the location information of the master wireless access point A1 (that is, the first location information) and the air pressure value and temperature value measured by the barometer B2 built into the agent wireless access point A2. Compared with conventional positioning methods, this can significantly reduce the positioning cost of the wireless access point A2.

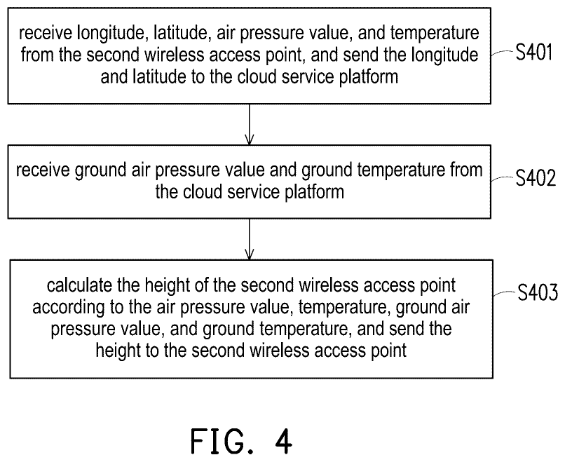

FIG. 4 is a flowchart of a positioning method according to an embodiment of the disclosure, wherein the positioning method may be implemented by the proxy server 100 as shown in FIG. 1. Please refer to FIG. 1 and FIG. 4. In step S401, the proxy server 100 receives longitude, latitude, air pressure value, and temperature from the second wireless access point A2, and sends the longitude and latitude to the cloud service platform 300. In step S402, the proxy server 100 receives ground air pressure value and ground temperature from the cloud service platform 300. In step S403, the proxy server 100 calculates the altitude of the second wireless access point A2 according to the air pressure value, temperature, ground air pressure value, and ground temperature, and sends the altitude to the second wireless access point A2. Regarding the implementation details of steps S401 to S403, they have been clearly explained in the above embodiments, so they will not be repeated in the following.

In summary, the proxy server and the positioning method provided by the embodiment of the disclosure may send the longitude and latitude from the location information of the master wireless access point to the cloud service platform to obtain the ground air pressure value and ground temperature. Then, based on the air pressure value and temperature provided by the agent wireless access point and the ground air pressure value and ground temperature provided by the cloud service platform, the altitude of the agent wireless access point is calculated. The altitude is then sent to the agent wireless access point, enabling the agent wireless access point to calculate its location information accordingly, thereby reducing the positioning cost for the agent wireless access point.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A proxy server, applicable to a mesh network, the proxy server connecting the mesh network and a cloud service platform, the mesh network comprising a plurality of wireless access points, wherein the wireless access points comprise a first wireless access point and a second wireless access point, the proxy server is configured to:
receive a longitude, a latitude, an air pressure value, and a temperature value from the second wireless access point, and send the longitude and the latitude to the cloud service platform;
receive a ground air pressure value and a ground temperature value from the cloud service platform; and
calculate an altitude of the second wireless access point according to the air pressure value, the temperature value, the ground air pressure value, and the ground temperature value, and send the altitude to the second wireless access point.

2. The proxy server according to claim 1, wherein the second wireless access point comprises a barometer.

3. The proxy server according to claim 1, wherein the first wireless access point is a master wireless access point in the mesh network.

4. A positioning method, applicable to a proxy server, a mesh network, and a cloud service platform, the mesh network comprising a plurality of wireless access points, the wireless access points comprising a first wireless access point and a second wireless access point, the positioning method comprising:
receiving a longitude, a latitude, an air pressure value, and a temperature value from the second wireless access point through the proxy server, and sending the longitude and the latitude to the cloud service platform;
receiving a ground air pressure value and a ground temperature value from the cloud service platform through the proxy server; and
calculating an altitude of the second wireless access point according to the air pressure value, the temperature value, the ground air pressure value, and the ground temperature value through the proxy server, and sending the altitude to the second wireless access point.

5. The positioning method according to claim 4, wherein the second wireless access point further comprises a barometer.

6. The positioning method according to claim 4, wherein the first wireless access point is a master wireless access point in the mesh network.
